(19) United States
(12) Patent Application Publication
(10) Pub. No.: US 2012/0231295 A1
(43) Pub. Date: Sep. 13, 2012

(54) METHOD OF FABRICATING A COMPONENT AND A COMPONENT

(75) Inventors: Srikanth Chandrudu KOTTILINGAM, Simpsonville, SC (US); Gene MURPHY, Pelzer, SC (US); Yan CUI, Greenville, SC (US)

(73) Assignee: GENERAL ELECTRIC COMPANY, Schenectady, NY (US)

(21) Appl. No.: 13/042,625

(22) Filed: Mar. 8, 2011

(51) Int. Cl. B32B 15/01; B23K 15/00

(52) U.S. Cl. 428/680; 428/615; 219/121.35; 428/668

(57) ABSTRACT

A method of fabricating a component and a component are disclosed. The method includes beam brazing a pre-sintered preform to the component to form a beam-brazed portion. The component includes a beam-brazed portion formed by a pre-sintered preform.

### FIELD OF THE INVENTION

The present invention is directed to manufactured components and processes of fabricating manufactured components. More specifically, the present invention relates beam-brazed components and processes of fabricating beam-brazed components.

### BACKGROUND OF THE INVENTION

In general, turbine blades can be coupled to a central hub that is attached to a driven shaft with the blades radially disposed with respect to the axis of the hub and shaft. The blades can include an airfoil that imparts a rotational energy rotating the shaft. Some gas turbine blades have shrouds at the outer extremities of the associated airfoils. The blade shrouds are nested in close proximity to each other. Many turbine blade shrouds have a mechanical interlocking feature in the form of a notch that allows each blade to be physically interlocked at its shroud with an adjacent blade.

There are a variety of mechanisms that may cause wear in the mechanical interlocking feature. For example, during operation of the turbine there may be vibration of adjacent blades with respect to each other and the hub. The aforementioned interlocking feature can facilitate mitigation of airfoil vibration such that the stresses induced within the blades during operation are in turn mitigated. The close tolerances of the interlocking features may increase wear in the vicinity of the interlocking features as the adjacent notches rub against each other.

Further, during starting operations, as the temperatures of the shrouds, airfoils, and hub (as well as all other components that interface with hot gases) vary within each individual component and with respect to other adjacent components, and the turbine is accelerated to an operating speed, the blades and shrouds can twist such that the notches at times contact each other and attain an interlocked condition. Also, during stopping operations variation in component temperatures can be substantially reversed from the variations associated with startup as well as turbine deceleration such that the blades and shrouds can twist so that the notches do not contact each other and attain a non-interlocked condition.

Many shroud materials do not have the surface wear resistance characteristics to resist the long-term cumulative effects of contact and rubbing.

A component and a process of fabricating a component that do not suffer from one or more of the above drawbacks would be desirable in the art.

### BRIEF DESCRIPTION OF THE INVENTION

In an exemplary embodiment, a method of fabricating a component includes beam brazing a pre-sintered preform or a flexible tape to the component to form a beam-brazed portion.

In another exemplary embodiment, a method of fabricating a component includes preparing at least a portion of the component for receiving a sintered preform, forming a pre-sintered preform, positioning the sintered preform on the component, and beam brazing the sintered preform to at least a portion of the component.

In another exemplary embodiment, a component includes a non-brazed portion and an beam-brazed portion formed by a pre-sintered preform.

### BRIEF DESCRIPTION OF THE DRAWINGS

FIG. 1 is a perspective view of a portion of an exemplary combustion turbine.

FIG. 2 is a top view of region 2 shown in FIG. 1.

FIG. 3 is a flow chart of an exemplary method for fabricating an electron beam-brazed component according to the disclosure.

FIG. 4 is an enlarged top view of an electron beam-brazed component according to the disclosure.

### DETAILED DESCRIPTION OF THE INVENTION

Provided is an exemplary beam-brazed component and exemplary processes of fabricating a beam-brazed component. Embodiments of the present disclosure mitigate long-term cumulative effects of contact and rubbing, prevent maintenance shutdowns and repairs resulting from twisting and vibration of components, include increased wear resistance and/or hardness, decrease susceptibility to wear, and combinations thereof.

The beam-brazed component is any suitable component formed by a pre-sintered preform (PSP). Suitable components include gas turbine components (for example, surfaces on shrouds, blades or bucket surfaces, interlocking features, or hardfacing surfaces) or any other suitable metal or metal-composite component.

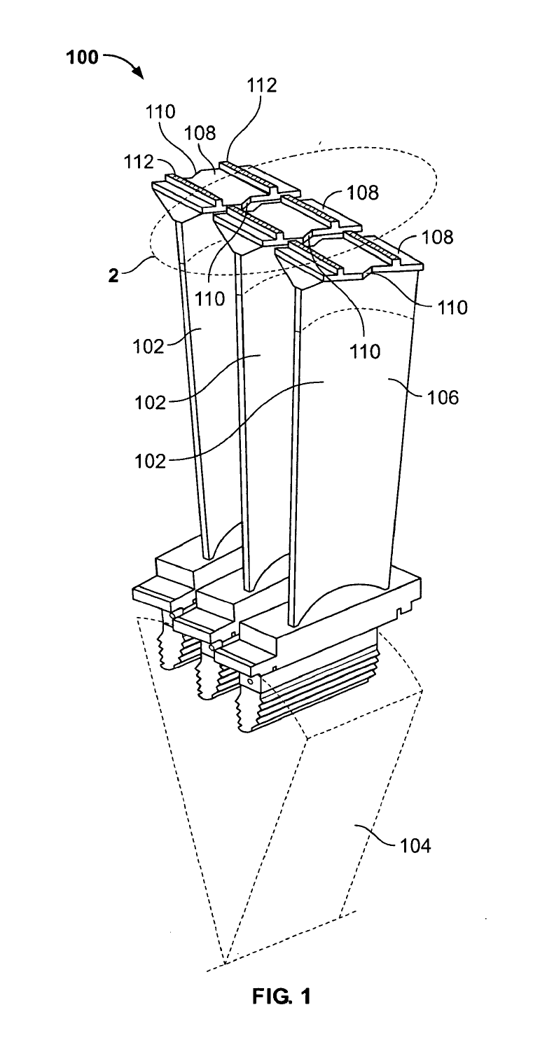

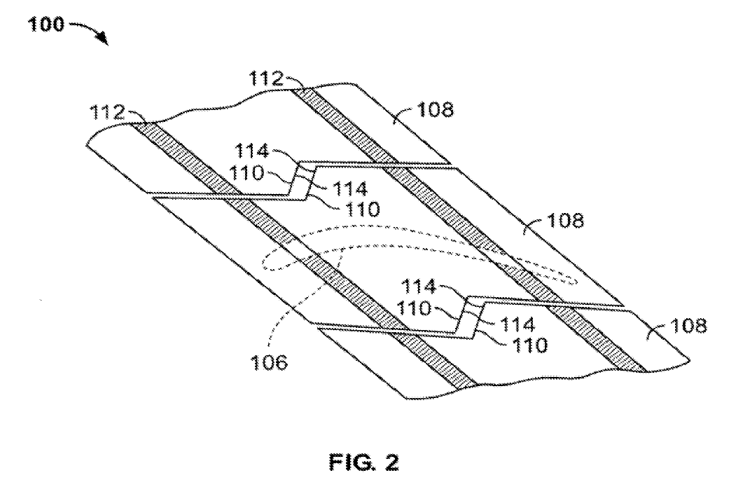

FIG. 1 is a perspective view of a section of a combustion turbine 100 including components or portions of components suitable for being electron beam-brazed and/or laser beam-brazed. For example, turbine 100 has a plurality of turbine blades 102 coupled to a hub 104. The hub 104 is coupled to a turbine shaft (not shown). The blades 102 include corresponding airfoils 106 and corresponding turbine blade shrouds 108 fixedly coupled to the airfoils 106. The shrouds 108 have two correspondingly opposite interlocking features 110. Protrusions 112 facilitate coupling of the blade 102 reducing or eliminating circumferential movement and vibration. The portion of FIG. 1 enclosed by the dotted line and labeled 2 is illustrated in FIG. 2. FIG. 2 is a top view the shroud 108 without hardfacing that may be used with combustion turbine 100. The shroud 108 is illustrated with the interlocking features 110 on each end. The interlocking features 110 have a mating surface 114.

The component includes a substrate formed of, for example, a superalloy material. In one embodiment, the substrate has a composition, by weight, of about 14% chromium, about 9.5% cobalt, about 3.8% tungsten, about 1.5% molybdenum, about 4.9% titanium, about 3.0% aluminum, about 0.1% carbon, about 0.01% boron, about 2.8% tantalum, and a balance of nickel. In one embodiment, the substrate has a composition, by weight, of about 9.75% chromium, about 7.5% cobalt, about 3.5% titanium, about 4.2% aluminum, about 6.0% tungsten, about 1.5% molybdenum, about 4.8% tantalum, about 0.08% carbon, about 0.009% zirconium, about 0.009% boron, and a balance of nickel. In one embodiment, the substrate has a composition, by weight, of about 7.5% cobalt, about 7.0% chromium, about 6.5% tantalum, about 6.2% aluminum, about 5.0% tungsten, about 3.0% rhenium, about 1.5% molybdenum, about 0.15% hafnium, about 0.05% carbon, about 0.004% boron, about 0.01% yttrium, and a balance of nickel. In one embodiment, the substrate has a composition, by weight, of about 9.75% chromium, about 7.5% cobalt, about 4.2% aluminum, about 3.5% titanium, about 1.5% molybdenum, about 6.0% tungsten, about 4.8% tantalum, about 0.5% niobium, about 0.15% hafnium, about 0.05% carbon, about 0.004% boron, and a balance of nickel. In one embodiment, the substrate has a composition, by weight, of about 8.35% chromium, about 9.50% cobalt, about 5.50% aluminum, about 0.75% titanium, about 9.50% tungsten, about 0.50% molybdenum, about 3.05% tantalum, 0.09% carbon, about 1.50% hafnium, and a balance of nickel. In one embodiment, the substrate has a composition, by weight, of about 0.06% carbon, about 9.80% chromium, about 7.50% cobalt, about 1.50% molybdenum, about 4.20% aluminum, about 3.50% titanium, about 4.80% tantalum, about 6.00% tungsten, about 0.50% niobium, about 0.15% hafnium, and a remainder 62% nickel.

In one embodiment, the substrate includes a superalloy that is capable of resisting creep at high temperatures, for example, temperatures of a hot gas path in a gas turbine. For example, in one embodiment, a first portion of the substrate maintains creep strength above a first/higher temperature, for example, about 1000° F., about 1250° F., about 1500° F., about 2000° F., or about 3000° F., and a second portion of the substrate is resistant to heat above a second/lower temperature, for example, between 800° F. and 1250° F., about 800° F., about 1000° F., about 1250° F., about 1500° F., or about 2000° F. In one embodiment, additional heating is provided, for example, by an induction heater (not shown).

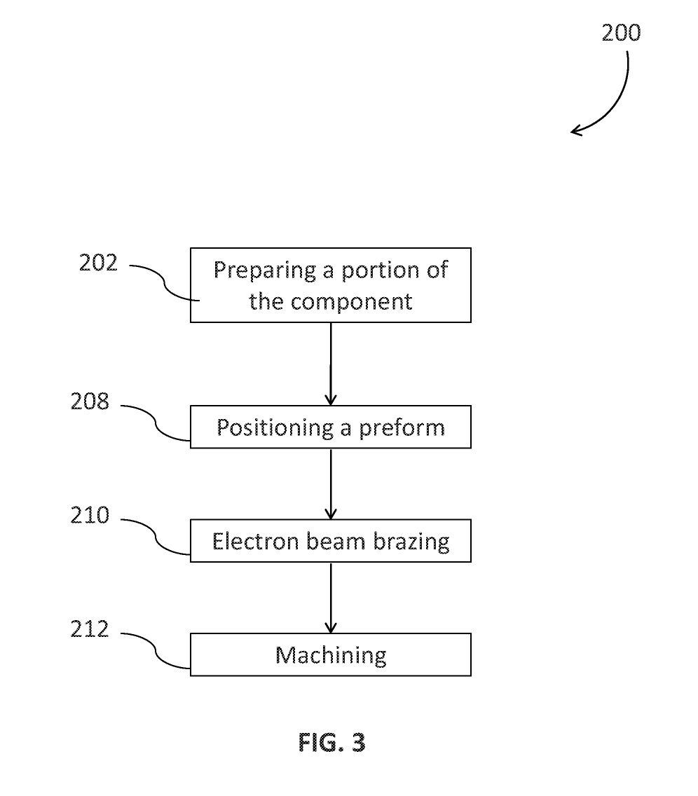

FIG. 3 is a schematic diagram of an exemplary method 200 for fabricating the beam-brazed component. Method step 202 includes preparing a portion of the component (for example, the surface 114 shown in FIG. 2 of the interlocking feature 110). The preparing of step 202 includes any suitable sub-steps, including, but not limited to, removing any loose surface contaminants, removing applied coating materials, removing metallurgical impurities (for example, oxidized surface layers), removing surface irregularities, or combinations thereof. In one embodiment, the preparing of step 202 includes using mild detergents, mild abrasives, and light machining. In a further embodiment, step 202 includes additional preparatory sub-steps, including, but not limited to, removing sub-surface material deformations, mitigating surface irregularities by machining, or combinations thereof.

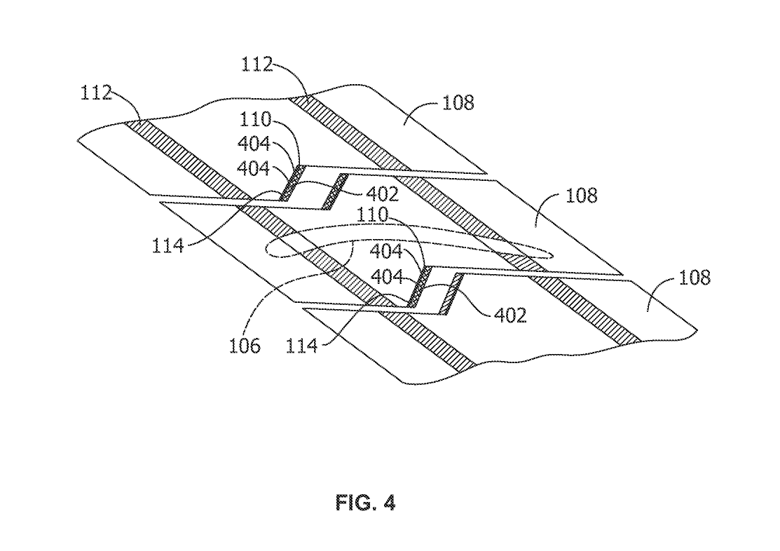

Method step 208 includes positioning a preform 402 (for example, the sintered preform or a first and second pre-sintered preform) on the component or the portion of the component to be beam-brazed (for example, the interlocking feature 110). In one embodiment, the portion of the component to be beam-brazed is heated to a predetermined temperature, for example, between about 2100° F. and about 2225° F. As shown in FIG. 4, in one embodiment, the component is the shroud 108 with a coupled hardface preform 402. The preform 402 is held in place on mating surface 114 of the interlocking feature 110 by at least one discrete tack weld 404. In one embodiment, two tack welds 404 are used to facilitate preform 402 adherence to surface 114.

In one embodiment, the pre-sintered preform (PSP) has a composition, by weight, of about 27.00% to about 30.00% molybdenum, about 16.50% to about 18.50% chromium, up to about 1.50% iron, up to about 1.50% nickel, up to about 0.15% oxygen, up to about 0.08% carbon, up to about 0.03% phosphorus, up to about 0.03% sulfur, and a balance of cobalt. In one embodiment, the PSP has a composition, by weight, of about 0.70% to about 1.00% carbon, about 26.00% to about 30.00% chromium, about 1.00% silicon, about 4.00% to about 6.00% nickel, about 3.00% iron, about 1.25% vanadium, about 0.10% boron, about 18.00% to about 21.00% tungsten, and a balance of cobalt. In one embodiment, the PSP has a composition, by weight, of about 22.00% to about 24.74% chromium, about 9.00% to about 11.00% nickel, about 6.50% to about 7.60% tungsten, about 3.00% to about 4.00% tantalum, about 2.60% to about 3.16% boron, about 0.55% to about 0.65% carbon, about 0.30% to about 0.60% zirconium, about 0.15% to about 0.30% titanium, up to about 1.30% iron, up to about 0.40% silicon, up to about 0.10% manganese, up to about 0.02% sulfur, and a balance of cobalt. In one embodiment, the PSP has a composition, by weight, of about 17.00% nickel, about 19.00% chromium, about 4.00% tungsten, about 0.40% carbon, about 0.80% boron, about 8.00% silicon, and a balance of cobalt.

In a further embodiment, the composition includes a mixture of one or more compositions, for example, about 80% a first composition and about 20% a second composition, about 60% a first composition and about 40% a second composition, about 50% a first composition and about 50% a second composition, or any other suitable composition selected for providing desired properties.

The PSP is a suitable predetermined geometry or corresponding geometries. Suitable geometries include a substantially planar geometry (for example, a flat plate), a tape-like geometry (for example, a flexible tape capable of being rolled, a flexible tape capable of bending at a right angle without mechanical forces, or a flexible tape having a predetermined length), a substantially consistent thickness geometry (for example, about 0.030 inches, about 0.160 inches, or between about 0.020 inches and about 0.080 inches), a rigid tape, a varying thickness geometry (for example, having a thickness of about 0.010 inches in a first region and having a thickness of about 0.020 inches in a second region or having a thickness of about 0.020 inches in a first region and having a thickness of about 0.030 inches in a second region), or combinations thereof. In one embodiment having the first PSP and the second PSP, the first PSP and the second PSP include a substantially identical geometry. In another embodiment, the first PSP and the second PSP have different geometries (for example, the first PSP having thicker regions corresponding to thinner regions in the second PSP).

In one embodiment, a flexible tape is used in addition to or alternative to the PSP. The flexible tape is formed by combining a first composition with a second composition along with a binder and then rolling the mixture to form tape-like or rope-like structures. The flexible tape is capable of being bent to several geometries, includes a predetermined thickness, for example, about 0.020 inches to about 0.125 inches, and is capable of being cut to a predetermined length.

Method step 210 includes beam brazing the component or the portion of the component (for example, beam brazing the preform 402 to the mating surface 114). In one embodiment, the beam brazing of step 210 includes a heating cycle sub-step and a cooling cycle sub-step. The heating cycle sub-step includes placing the shroud 108, with the preform 402 tack welded to the interlocking features 110, into an electron beam welding chamber (not shown) at a predetermined temperature (for example, at room temperature or about 70° F.). To facilitate the brazing process, a non-oxidizing atmosphere within the electron beam welding chamber is provided (for example, by evacuating the electron beam welding chamber). In one embodiment, the evacuated electron beam welding chamber is evacuated to a predetermined pressure (for example, 0.067 Pa or less).

A portion of the component is locally heated by the beam at a predetermined rate (for example, about 250° F. per minute) by a defocused electron beam, for example, the beam being selectively positioned or oscillated to spread heat over a predetermined region of the combustion turbine component 100. The predetermined region may be defined by a predetermined path for on the portion of the component. In one embodiment, the defocused electron beam provides substantially uniform heating of the predetermined region. Additionally or alternatively, in one embodiment, the defocused electron beam is formed by having increased deflection in comparison to a focused beam that may be used for electron beam welding. Upon reaching the predetermined temperature, the predetermined temperature is maintained for a predetermined period of time (for example, between about 2 and about 5 minutes) and the predetermined region is sequentially heated to a brazing temperature by the defocused electron beam. In one embodiment, the predetermined region is increased to a higher temperature (for example, about 1800° F.) at a predetermined rate (for example, 250° F. per minute) and maintained for a predetermined period (for example, 5 minutes). In this embodiment, the predetermined region is next increased to the brazing temperature (for example, about 2200° to 2225° F.) at a predetermined rate (for example, 350° F. per minute) and maintained for a predetermined period of time (for example, about 5 minutes).

Method step 212 includes machining the beam-brazed component or a beam-brazed portion of the component. For example, minor machining (for example, of hardfacing preform 402 shown in FIG. 4) may be performed to mitigate surface irregularities and to achieve predetermined dimensions (for example, hardfacing dimensions substantially similar to the associated dimensions of the mating surface 114 shown in FIG. 4).

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is needed is:

1. A method of fabricating a component, comprising:
beam brazing a pre-sintered preform or a flexible tape to the component to form a beam-brazed portion.

2. The method of claim 1, wherein the beam brazing is performed by a defocused electron beam.

3. The method of claim 1, wherein the component includes a substrate formed of a composition selected from the group consisting of:
by weight, about 14% chromium, about 9.5% cobalt, about 3.8% tungsten, about 1.5% molybdenum, about 4.9% titanium, about 3.0% aluminum, about 0.1% carbon, about 0.01% boron, about 2.8% tantalum, and a balance of nickel;
by weight, about 9.75% chromium, about 7.5% cobalt, about 3.5% titanium, about 4.2% aluminum, about 6.0% tungsten, about 1.5% molybdenum, about 4.8% tantalum, about 0.08% carbon, about 0.009% zirconium, about 0.009% boron, and a balance of nickel;
by weight, about 7.5% cobalt, about 7.0% chromium, about 6.5% tantalum, about 6.2% aluminum, about 5.0% tungsten, about 3.0% rhenium, about 1.5% molybdenum, about 0.15% hafnium, about 0.05% carbon, about 0.004% boron, about 0.01% yttrium, and a balance of nickel;
by weight, about 9.75% chromium, about 7.5% cobalt, about 4.2% aluminum, about 3.5% titanium, about 1.5% molybdenum, about 6.0% tungsten, about 4.8% tantalum, about 0.5% niobium, about 0.15% hafnium, about 0.05% carbon, about 0.004% boron, and a balance of nickel;
by weight, of about 8.35% chromium, about 9.50% cobalt, about 5.50% aluminum, about 0.75% titanium, about 9.50% tungsten, about 0.50% molybdenum, about 3.05% tantalum, 0.09% carbon, about 1.50% hafnium, and a balance of nickel; and
by weight, of about 0.06% carbon, about 9.80% chromium, about 7.50% cobalt, about 1.50% molybdenum, about 4.20% aluminum, about 3.50% titanium, about 4.80% tantalum, about 6.00% tungsten, about 0.50% niobium, about 0.15% hafnium, and a remainder 62% nickel.

4. The method of claim 1, wherein the beam brazing is of the pre-sintered preform, further comprising preparing a portion of the component prior to forming the beam-brazed portion, wherein the preparing comprises removing one or more of surface contaminants, applied coating materials, metallurgical impurities, surface irregularities, sub-surface material deformations, and combinations thereof.

5. The method of claim 1, wherein the beam brazing is of the pre-sintered preform, further comprising forming the pre-sintered preform from a pre-sintered preform mixture.

6. The method of claim 5, wherein the pre-sintered preform mixture includes a mixture selected from the group consisting of:
by weight, a first composition of about 27.00% to about 30.00% Mo, about 16.50% to about 18.50% CR, up to about 1.50% Fe, up to about 1.50% Ni, up to about 0.15% 0, up to about 0.08% C, up to about 0.03% P, up to about 0.03% S, and a balance of Co;
by weight, a second composition of about 0.70% to about 1.00% C, about 26.00% to about 30.00% CR, about 1.00% SI, about 4.00% to about 6.00% Ni, about 3.00% Fe, about 1.25% V, about 0.10% B, about 18.00% to about 21.00% W, and a balance of Co;
by weight, a third composition of about 22.00% to about 24.74% Cr, about 9.00% to about 11.00% Ni, about 6.50% to about 7.60% W, about 3.00% to about 4.00% Ta, about 2.60% to about 3.16% B, about 0.55% to about 0.65% C, about 0.30% to about 0.60% Zr, about 0.15% to about 0.30% Ti, up to about 1.30% Fe, up to about 0.40% Si, up to about 0.10% Mn, up to about 0.02% S, and a balance of Co;
by weight, a fourth composition of about 17.00% Ni, about 19.00% Cr, about 4.00% W, about 0.40% C, about 0.80% B, about 8.00% Si, and a balance of Co;
and combinations thereof.

7. The method of claim 5, wherein the beam brazing is of the pre-sintered preform, wherein the pre-sintered preform mixture includes a hardfacing material and a brazing material.

8. The method of claim 1, wherein the beam brazing is of the pre-sintered preform, further comprising positioning the pre-sintered preform before beam brazing the pre-sintered preform.

9. The method of claim 8, wherein the positioning comprises using a tack weld to adhere the pre-sintered preform to the component.

10. The method of claim 1, wherein the beam brazing is of the pre-sintered preform, wherein the pre-sintered preform includes a substantially planar geometry.

11. The method of claim 1, wherein the beam brazing is of the pre-sintered preform, wherein the pre-sintered preform includes a tape-like geometry.

12. The method of claim 1, wherein the beam brazing is of the pre-sintered preform, wherein the beam brazing is performed in an evacuated electron beam welding chamber.

13. The method of claim 1, wherein the beam brazing is of the flexible tape.

14. The method of claim 1, wherein the beam brazing is laser beam brazing.

15. A method of fabricating a component, comprising:
preparing at least a portion of the component for receiving a sintered preform;
forming a pre-sintered preform;
positioning the sintered preform on the component; and
beam brazing the sintered preform to at least a portion of the component.

16. A component, comprising a non-brazed portion and a beam-brazed portion formed by a pre-sintered preform.

17. The component of claim 16, wherein the component includes a substrate formed of a composition selected from the group consisting of:
by weight, about 14% chromium, about 9.5% cobalt, about 3.8% tungsten, about 1.5% molybdenum, about 4.9% titanium, about 3.0% aluminum, about 0.1% carbon, about 0.01% boron, about 2.8% tantalum, and a balance of nickel;
by weight, about 9.75% chromium, about 7.5% cobalt, about 3.5% titanium, about 4.2% aluminum, about 6.0% tungsten, about 1.5% molybdenum, about 4.8% tantalum, about 0.08% carbon, about 0.009% zirconium, about 0.009% boron, and a balance of nickel;
by weight, about 7.5% cobalt, about 7.0% chromium, about 6.5% tantalum, about 6.2% aluminum, about 5.0% tungsten, about 3.0% rhenium, about 1.5% molybdenum, about 0.15% hafnium, about 0.05% carbon, about 0.004% boron, about 0.01% yttrium, and a balance of nickel; and
by weight, about 9.75% chromium, about 7.5% cobalt, about 4.2% aluminum, about 3.5% titanium, about 1.5% molybdenum, about 6.0% tungsten, about 4.8% tantalum, about 0.5% niobium, about 0.15% hafnium, about 0.05% carbon, about 0.004% boron, and a balance of nickel.

18. The component of claim 16, wherein the pre-sintered preform mixture includes a composition selected from the group consisting of:
by weight, a first composition of about 27.00% to about 30.00% Mo, about 16.50% to about 18.50% CR, up to about 1.50% Fe, up to about 1.50% Ni, up to about 0.15% O, up to about 0.08% C, up to about 0.03% P, up to about 0.03% S, and a balance of Co;
by weight, a second composition of about 0.70% to about 1.00% C, about 26.00% to about 30.00% CR, about 1.00% SI, about 4.00% to about 6.00% Ni, about 3.00% Fe, about 1.25% V, about 0.10% B, about 18.00% to about 21.00% W, and a balance of Co;
by weight, a third composition of about 22.00% to about 24.74% Cr, about 9.00% to about 11.00% Ni, about 6.50% to about 7.60% W, about 3.00% to about 4.00% Ta, about 2.60% to about 3.16% B, about 0.55% to about 0.65% C, about 0.30% to about 0.60% Zr, about 0.15% to about 0.30% Ti, up to about 1.30% Fe, up to about 0.40% Si, up to about 0.10% Mn, up to about 0.02% S, and a balance of Co;
by weight, a fourth composition of about 17.00% Ni, about 19.00% Cr, about 4.00% W, about 0.40% C, about 0.80% B, about 8.00% Si, and a balance of Co;
and combinations thereof.

19. The component of claim 16, wherein the component is a portion of a bucket surface of a gas turbine.

20. The component of claim 16, wherein the pre-sintered preform includes a substantially planar geometry.
